(19) United States
(12) Patent Application Publication
(10) Pub. No.: US 2008/0226158 A1
(43) Pub. Date: Sep. 18, 2008

(54) Data Processor and Data Processing Method

(75) Inventors: Chikako ABE, Hitachinaka (JP); Hitoshi SUGAHARA, Hitachiota (JP); Tomohiro FUNAKOSHI, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Tokyo (JP)

(21) Appl. No.: 12/046,129

(22) Filed: Mar. 11, 2008

(30) Foreign Application Priority Data
Mar. 12, 2007 (JP) 061183-2007

(51) Int. Cl. G06K 9/00

(52) U.S. Cl. 382/149

(57) ABSTRACT

There is provided a data processor and a data processing method for displaying feature quantities for facilitating classification of defects extracted by an appearance checking device, receive defect checking information including at least coordinates of a plurality of defects transmitted from the appearance checking device for extracting defects of a sample via a communication line and defect review information including at least feature quantities transmitted from a reviewing device for acquiring images of the defects and giving the feature quantities of the defects via the communication line, displaying a graph field where at least two of the feature quantities which are plotted along axes on a display, and displaying the defects on positions of the graph field corresponding to the given feature quantities.

### BACKGROUND OF THE INVENTION

1. Field of the Invention

The present invention relates to a data processor and a data processing method for sorting information relating to defects so as to classify the defects, the information being from an appearance checking device for detecting foreign matters on surfaces of semiconductor wafers, photomasks, magnetic discs and liquid crystal substrates, and defects of their patterns, and from a reviewing device for observing defects such as foreign matters.

2. Description of the Related Art

Various defects such as disconnection and contact of surface pattern, adhesion of foreign matters and scratches are occasionally generated on surface of sample at a manufacturing process. For example, at the manufacturing process for semiconductor device, foreign matters on semiconductor wafer and disconnection and contact of circuit pattern cause defective products. For this reason, it is necessary to quantify these defects and always monitor whether problems of manufacturing apparatus and manufacturing environment arise. Defects which are detected on surface of the semiconductor wafer by the appearance checking device include fatal defects which influence electric properties in completed semiconductor device, and defects which do not influence them. The defects which do not influence the electric properties include false defects caused by electric noises at the time of the defect detecting process in appearance checking device. Therefore, images of the defects detected by appearance checking device are acquired to be observed, and a check should be made whether the defects fatally influence the product.

Coordinates of the defects extracted by appearance checking device are transmitted to reviewing device, and the reviewing device automatically finds the defects while correcting the transmitted coordinates, so as to execute ADR (Automatic Defect Review) for automatically acquiring the images of the defects. The viewing device executes ADC (Automatic Defect Classification) for automatically classifying defects on the acquired images according to sizes, shapes and types of the defects. In such a manner, the automatization has been tried so that variation of results due to human intervention is not generated, but the accuracy of results cannot have been improved due to an increase in types of defects caused by miniaturization of semiconductor device and an increase in the number of defects extracted by appearance checking device.

In recent years, defect extracting sensitivity has been improved by using electron microscope as the appearance checking device, but false defects are extracted due to heightening of a signal noise level. This causes the increase in the number of defects. As a countermeasure against this situation, a RDC (Real-Time Defect Classification) function for classifying defects during a check so as to remove noises is incorporated in appearance checking device, so that false defects are tried to be removed.

At the manufacturing processes for semiconductor device, it is important that reviewing device observes and classifies defects transmitted from appearance checking device, finds fatal defects, and determines the causes of the defects early. However, the problem is that the accuracy of classification of defects is hardly improved by not only human works but also automatization because the number of defects extracted by appearance checking device and false defects are increased.

As a countermeasure against this situation, a data processor having a special function for data process relating to defects is connected between an appearance checking device and a reviewing device. Information about defect IDs given for identifying defects transmitted from the appearance checking device and information transmitted from the reviewing device are simultaneously displayed on a display of the data processor so that an operator can easily check and classify the defects. In such a manner, the accuracy of the classification of defects is tried to be improved (for example, see Japanese Patent Application Laid-Open No. 2006-173589).

The clue to the classification of defects is feature quantity incidental to each defect. However, many kinds of feature quantities are present, and the feature quantities to be displayed on the screen are figures. A determination as to which category one defect is classified in is difficult just by displaying the feature quantities on the screen.

### SUMMARY OF THE INVENTION

It is an object of the present invention to provide a data processor and a data processing method for displaying a feature quantity for facilitating classification of defects extracted by an appearance checking device.

In an embodiment of the present invention, defect checking information including at least coordinates of a plurality of defects transmitted from the appearance checking device for extracting the defects of a sample via a communication line, and defect review information including at least feature quantities transmitted from a reviewing device for acquiring images of the defects and giving the feature quantities of the defects via the communication line are received, a graph field where at least two of the feature quantities are plotted along axes is displayed on a display, and the defects are displayed on a position of the graph field corresponding to the given feature quantities.

According to the present invention, the data processor and the data processing method for displaying the feature quantity for facilitating the classification of defects extracted by the appearance checking device can be provided.

### BRIEF DESCRIPTION OF THE DRAWINGS

FIG. 1 is a system constitutional diagram of the present invention;

FIG. 2 is a system constitutional diagram of the present invention;

FIG. 3 is a display screen diagram illustrating one example of data contents displayed on a display of a data processor;

FIG. 4 is a screen diagram illustrating one example of an image displayed on the display of the data processor;

FIG. 5 is a screen diagram illustrating one example of an image to be used for analyzing a feature quantity;

FIG. 6 is a screen diagram illustrating one example of an image to be used for analyzing the feature quantity;

FIG. 7 is a screen diagram illustrating one example of a display setting screen of defect symbols;

FIG. 8 is a screen diagram illustrating a list of the feature quantities;

FIG. 9 is a flow chart illustrating a flow of a series of procedure;

FIG. 10 is a screen diagram illustrating one example of an image to be used for analyzing the feature quantity;

FIG. 11 is a flow chart illustrating a flow of a determination whether a defect is subject to be reviewed;

FIGS. 12A to 12D are pattern diagrams illustrating definition of respective points at the time of drawing a triangle or a square;

FIG. 13 is a screen diagram of a pull-down menu; and

FIG. 14 is a screen diagram illustrating one example of a graph of the feature quantities.

### DESCRIPTION OF REFERENCE NUMERALS

1: APPEARANCE CHECKING DEVICE
2: REVIEWING DEVICE
3: DATA PROCESSOR
4: COMMUNICATION LINE
30: SCREEN
400: IMAGE LIST DISPLAY SCREEN
500: GRAPH DISPLAY SCREEN
501: WAFER MAP
503: FIELD
504: VERTICAL AXIS SETTING FIELD
505: LATERAL AXIS SETTING FIELD
700: DISPLAY SETTING SCREEN
800: PULL-DOWN MENU

### DESCRIPTION OF THE PREFERRED EMBODIMENTS

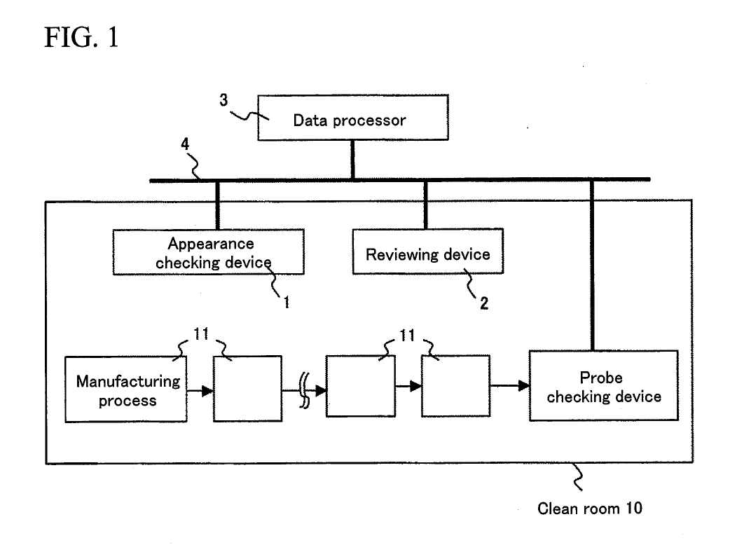

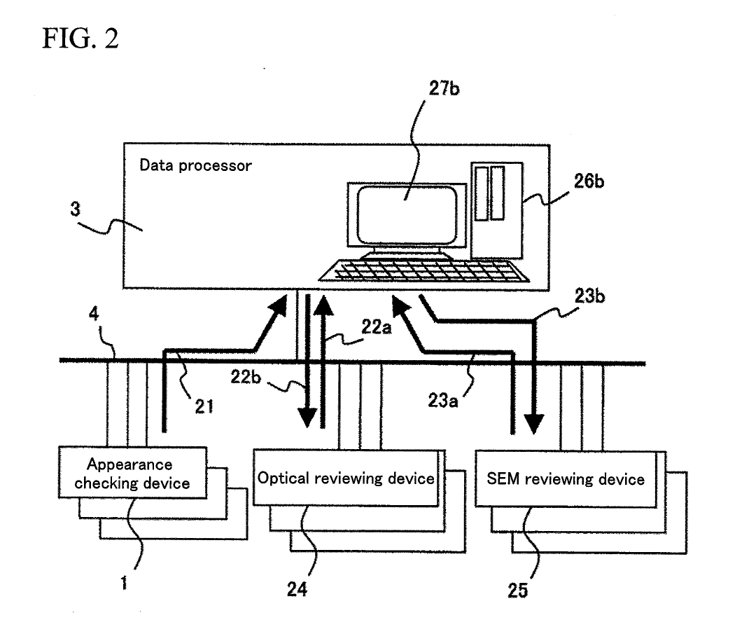

An entire constitution of the present invention is described with reference to FIGS. 1 and 2. An example where the present invention is applied to the manufacturing process for semiconductor device id described. FIGS. 1 and 2 are system constitutional diagrams of the present invention. A manufacturing device and an appearance checking device relating to the manufacturing process 11 for semiconductor device are installed in a clean room 10 where a clean environment is maintained. In the clean room 10, a probe checking device 5, an appearance checking device 1 and a reviewing device 2 are connected to a communication line 4. The probe checking device 5 tests an electric property of a completed semiconductor device at a final step of the manufacturing process 11. The appearance checking device 1 extracts a semiconductor wafer as a sample from a necessary part of the manufacturing process 11 so as to extract its defects. The reviewing device 2 acquires a review image of the defects extracted by the appearance checking device 1. The communication line 4 is connected to a data processor 3 which is installed outside the clean room 10. The appearance checking device 1 has a computer, a memory device and a display, not shown, and includes not only a function for extracting defects of a semiconductor device but also functions for saving data about defects in the memory device and transmitting the data to another device via the communication line 4. The reviewing device 2 has a computer, memory device and a display, not shown, and includes not only a function for reviewing defects of a semiconductor device but also functions for saving data about reviewed results of the defects in the memory device and transmitting the data to another device via the communication line 4. As shown in FIG. 2, the data processor 3 has a computer 26, which contains a microprocessor and a memory device, and a display 27, not shown, and includes functions for saving data transmitted via the communication line 4 in the memory device and executing various processes on the data about defects.

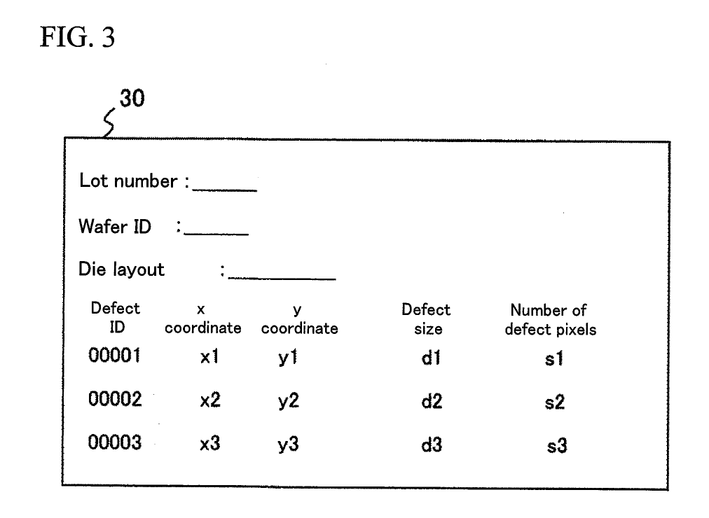

The contents of the data transmitted via the communication line 4 are described with reference to FIG. 2. FIG. 3 is a display screen diagram illustrating one example of the data contents displayed on the display of the data processor. Defect information 21 transmitted from the appearance checking device 1 includes a device ID of the appearance checking device 1, a lot number of a semiconductor wafer to be checked, a wafer ID, and a name of a die layout as displayed on a screen 30 in FIG. 3. As to the die layout, when one semiconductor device formed on a semiconductor wafer is called as a die, layout information such as a vertical dimension and a lateral dimension of the die and an alignment coordinate showing a position of the die with respect to a notch is represented by a predetermined symbol. The layout information includes a defect ID, an x coordinate, y coordinate, a defect size and the number of defect pixels for each of plural defects. The x coordinate and the y coordinate mean positions of defects represented by a coordinate system in the appearance checking device 1, and the defect size means a maximum width of a region in an image where a defect is recognizable. The number of defect pixels means the number of pixels of the region in an image where a defect is recognizable. As not shown in FIG. 3, but the information about a semiconductor wafer includes a symbol showing the checking step, a symbol showing a date of the check, a defect ADR image for each defect, and information about the defect feature quantities other than the defect size and the number of defect pixels. The defect ADR image is not an image acquired in the reviewing device 2 but an image of a defect extracted by the appearance checking device 1 itself. The information about the defect feature quantity means information about feature quantities for respective defects acquired by executing the RDC function for classifying defects by the appearance checking device 1 during checking. One example of the information about the defect feature quantity is described later.

In FIG. 2, the semiconductor wafer where extraction of defects by the appearance checking device 1 is finished is transferred to an optical reviewing device 24 and an SEM reviewing device 25 in order to observe the defects, and the defects are observed there. At the time of the observation, the information about the semiconductor wafer, namely, the lot number, the wafer ID and the checking step are specified, so that defect information 21 is acquired from the data processor 3 via the communication line 4. In the case where a plurality of appearance checking devices 1 is used, respective IDs of the devices are also specified. The defect information 21 includes not only the data shown in FIG. 3 but also a defect ADR image acquired by the appearance checking device 1.

Since the defect information 21 outputted by the appearance checking device 1 is huge quantities of data, a plurality of filter functions provided to the data processor 3 is used so as to be capable of selecting desired data from the defect information 21. Defect information 22b selected in such a manner is sent to the optical reviewing device 24, or defect information 23b is sent to the SEM reviewing device 25 via the communication line 4. Data formats of the defect information 22b and 23b are based on the defect information shown in FIG. 3.

The optical reviewing device 24 performs coordinate transformation using alignment information in the die layout from the sent defect information 22b so as to convert the coordinate data of defects, and searches and extracts defects by means of ADR. After the extraction of the defects, the optical reviewing device 24 acquires their images, and executes ADC. The optical reviewing device 24 sends ADR/ADC information 22a including the ADR images and the ADC results of the defects per defect or semiconductor wafer to the data processor 3 via the communication line 4.

Similarly to the optical reviewing device 24, the SEM reviewing device 25 performs coordinate transformation using the alignment information in the die layout from the transmitted defect information 23b so as to convert coordinate data of the defects, and searches and extracts the defects by means of ADR. After the extraction of the defects, the SEM reviewing device 25 acquires their images and executes ADC. The SEM reviewing device 25 sends ADR/ADC information 23a including the ADR images and the ADC results of the defects per defect or semiconductor wafer to the data processor 3 via the communication line 4.

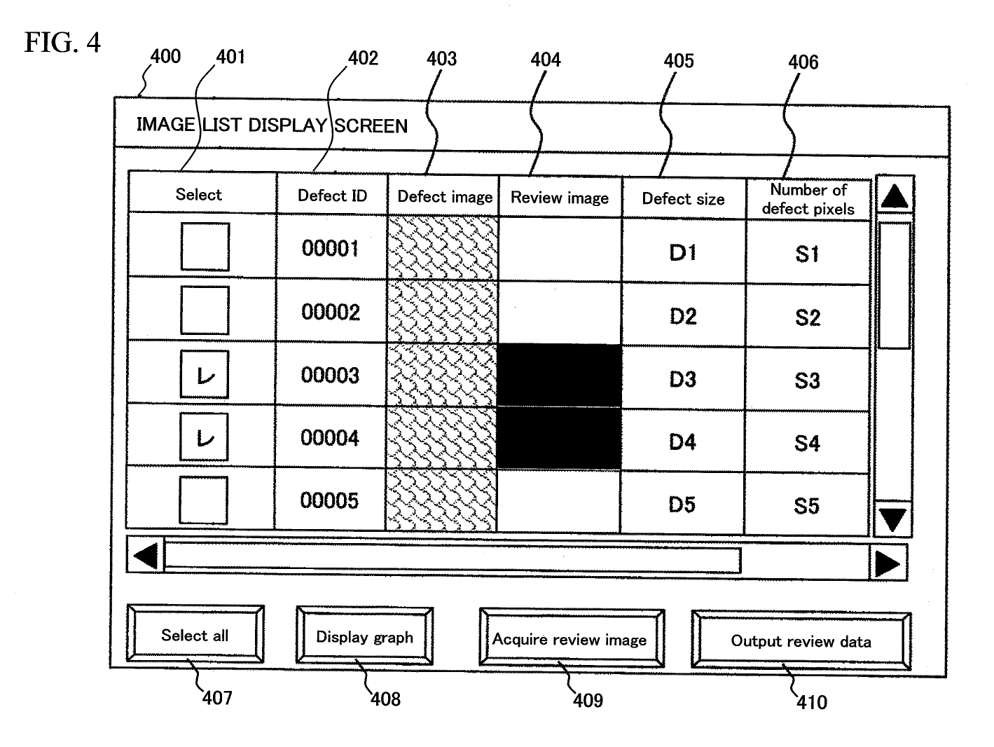

FIG. 4 is a screen diagram illustrating one example of an image displayed on the display of the data processor 3. A list of images and data per defect ID is displayed on an image list display screen 400. Defect IDs are displayed on a defect ID field 402, defect ADR images transmitted from the appearance checking device 1 are displayed on a defect image field 403, and the review images sent from the reviewing device 2 are displayed on a review image field 404 side by side. As the feature quantity of each defect, for example, the defect size is displayed on a defect size field 405, and the number of defect pixels is displayed on a defect pixel number field 406. As not shown in FIG. 4, the symbols representing the checking steps, the symbols representing the date of checks, and information about the defect feature quantity other than the defect sizes and the number of defect pixels are displayed as the information about the semiconductor wafer.

After the extraction of the defects by the appearance checking device 1, since the reviewing device 2 does not acquire a review image, a row of the review image field 404 is blank. Therefore, in order to display a review image, a pointer is adjusted to a selection field 401 by moving a mouse as an input device of the computer, and a button of the mouse is clicked, so that a check mark is placed on the selection field 401. In such a manner, a defect whose observation image is desired to be acquired is selected. When a data output button 410 for review is specified by clicking, coordinate data in the appearance checking device 1 relating to the selected defect is transmitted to the reviewing device 2, so that the image is acquired. When a select all button 407 is specified by clicking, check marks can be placed on all items on the selection field 401. The reviewing device 2 executes ADR, extracts a target defect based on the coordinate data for transmitted each defect ID, and acquires the images so as to save them in the memory device, not shown.

When a review image acquiring button 409 is specified by clicking, review images relating to the defects with check marks on the selection field 401 and the ADR/ADC information are transmitted from the reviewing device 2 to the data processor 3, and the review images are displayed on the review image field 404. As to defects whose review images do not have to be acquired, the review images of the defects are prevented from being acquired in such a manner that the check marks on the selection field 401 are deleted by an indication by clicking before an indication is made by clicking the review image acquiring button 409.

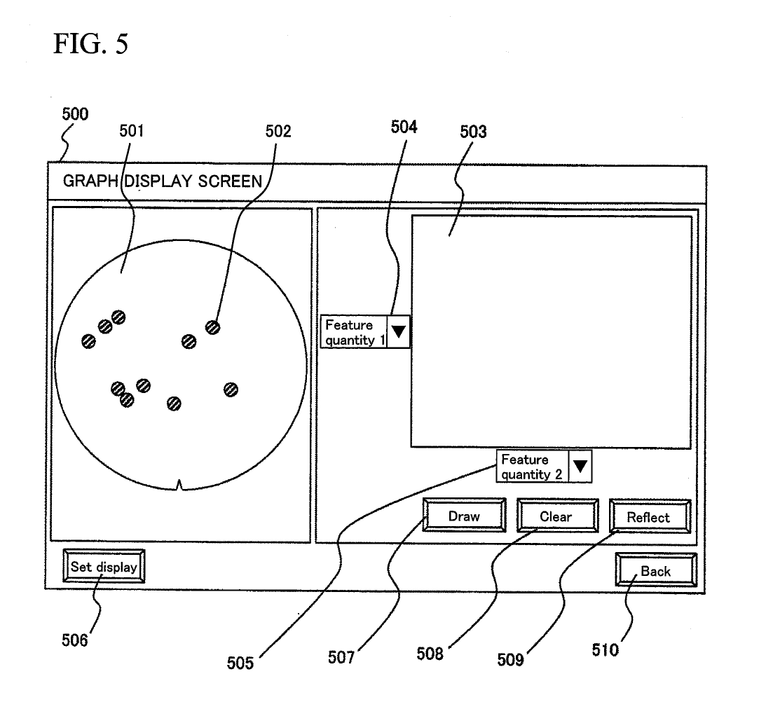

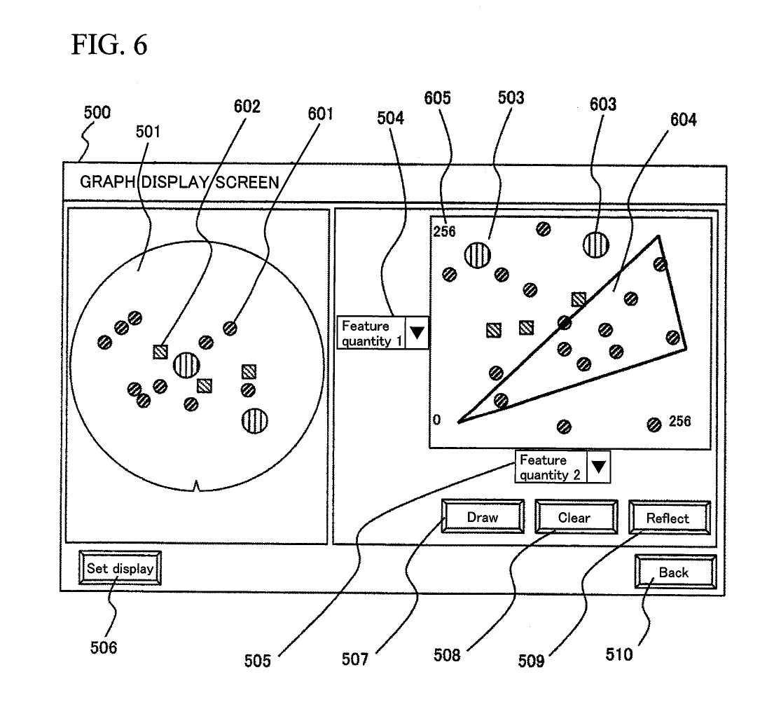

The displayed list of the defect ADR images, the review images and the feature quantities such as defect sizes per defect ID shown in FIG. 4 is suitable for understanding various feature quantities relating to one defect, but a determination of a tendency of each feature quantity of a plurality of defects is difficult with this list. Therefore, screens shown in FIGS. 5 and 6 are displayed, and the feature quantities of defects are analyzed. When a graph display button 408 in FIG. 4 is specified by clicking, the screen shown in FIG. 5 can be displayed.

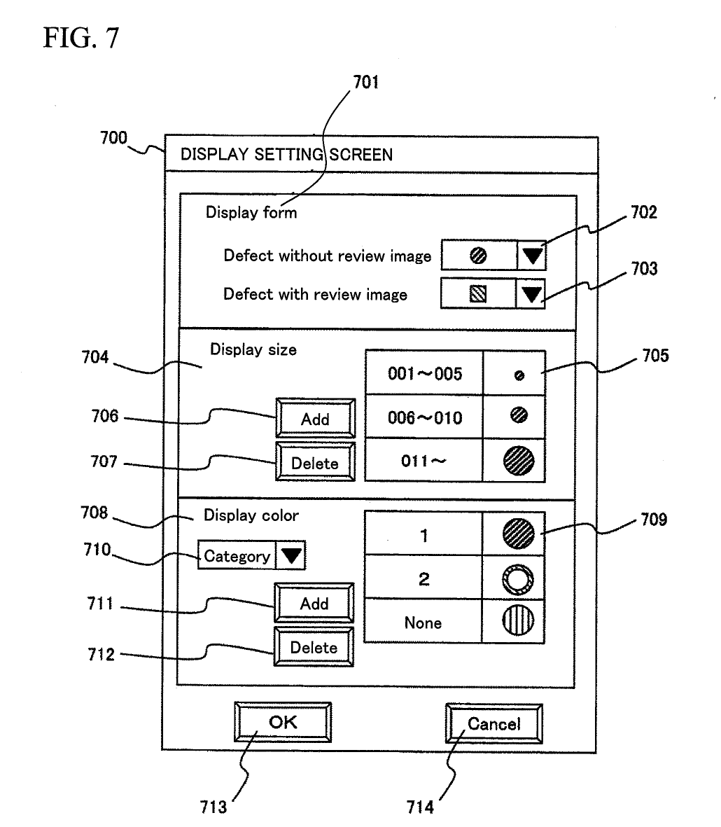

FIGS. 5 and 6 are screen diagrams illustrating examples of images to be used for analyzing the feature quantities. FIG. 7 is a screen diagram illustrating one example of a display setting screen of defect symbols. A field for displaying a wafer map 501 and a field 503 for displaying a graph of the feature quantity are displayed on the graph display screen 500 in FIG. 5. The reviewing device 2 corrects a coordinate of a defect extracted by the appearance checking device 1 into a coordinate of the reviewing device 2. Distribution of defects 502 on the semiconductor wafer is coded and displayed on the wafer map 501 based on the corrected coordinate in a visible manner. One kind of symbol is used as a default, but the symbol can be displayed so as to be visually discriminated from the other defects by changing a shape, a size and a color of the symbol using the screen shown in FIG. 7 based on the feature quantities of the defects with reflecting the ADC result of the reviewing device 2. When a back button 510 is specified by clicking, the display returns to the screen shown in FIG. 4.

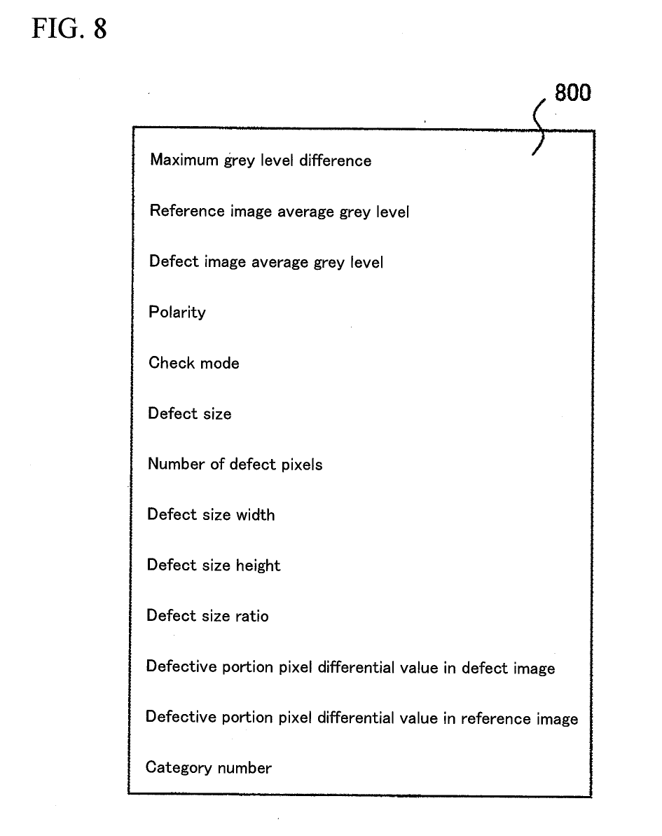

FIG. 8 is a screen diagram illustrating a list of the feature quantities. A pull-down menu 800 is displayed on a vertical axis setting field 504 or a lateral axis setting field 505 in the graph of FIG. 5. The screen of FIG. 8 is displayed on the vertical axis setting field 504 of FIG. 5. For example, when “maximum grey level difference” is specified by clicking, the feature quantity corresponding to “feature quantity 1” on the vertical axis of the field 503 for displaying the graph is “maximum grey level difference”, and the “maximum grey level difference” is displayed on the vertical axis setting field 504. Much the same is true on the lateral axis setting field 505. A scale 605 according to the respective feature quantities is automatically displayed. The feature quantity of the vertical axis setting field 504 or the lateral axis setting field 505 can be set as a default. For example, when the maximum grey level difference is set for a head item of the list of the feature quantities in the pull-down menu 800 shown in FIG. 8 as the default of the feature quantity 1 of the vertical axis setting field 504 shown in FIG. 5, the maximum grey level difference is automatically set on the lateral axis setting field 504. As the default of the feature quantity 2 of the lateral setting field 505, a reference image average grey level is set for a second item of the list of the feature quantities on the pull-down menu 800 shown in FIG. 8, the reference image average grey level is automatically set on the lateral axis setting field 505. When the feature quantities of the vertical axis and the lateral axis are arbitrarily specified, as shown in FIG. 6, distribution of the defects corresponding to each feature quantity selected from a lot of defects can be displayed on the field 503 for displaying a graph. When the feature quantity is changed, the display of the defects displayed on the field 503 is changed into a position corresponding to the changed feature quantity so as to be displayed on the field 503. The defects which do not have the changed feature quantities are not displayed on the field 503.

The feature quantities shown in FIG. 8 are described. The maximum grey level difference is an absolute value of brightness in a defective portion at the time of processing an image in a position determined as a defect and an image of its reference portion and acquiring a difference image. The reference image average grey level is an average value of brightness on a reference image of a pixel portion determined as a defective portion. The defect image average grey level is an average value of brightness on a defect image of a pixel portion determined as a defective portion. A polarity shows that a defective portion is brighter or darker than the reference image, “+” shows a bright defect, and “−” shows a dark defect. A checking mode is an image comparing system which is used at the time of detecting a defect, and includes die comparison, cell comparison and combined comparison. A defect size, the number of defect pixels, a defect size width and a defect size height show sizes of a detected defect. A unit of the number of defect pixels is a pixel. Units of the defect size width and the defect size height are micron, for example. A defect size ratio is a parameter which shows a ratio of the width to the height of the defect size. When the width and the height are equal to each other, the defect size ratio is 1, and when the width is twice as large as the height, the ratio is 2. A defective portion pixel differential value shows a differential value of a pixel portion determined as a defect. The defective portion pixel differential value shows a level of a change in shading in the pixel portion on the defective image or the reference image, a defective portion pixel differential value of the defective image is called as a defective portion pixel differential value in defective image, and a defective portion pixel differential value of a reference image is called as a defective portion pixel differential value in reference image. A category number is a number which is given to a category as a type of classification after a defect is classified, and includes circular distribution, eccentric distribution, random distribution, foreign matter, pattern short, and pattern defect. Some defects are classified so as to be redundant on a plurality of categories. When an unclassifiable defect is present, an unclassifiable category is created so that this defect can be conveniently reexamined at a later date.

When a display setting button in FIG. 5 or 6 is specified by clicking, the screen shown in FIG. 7 is displayed. A display shape setting field 701, a display size setting field 704 and a display color setting field 708 are provided on a display setting screen 700, and display of a symbol of a defect displayed in FIG. 5 or 6 can be specified.

Since an observation image is provided for some defects but not provided for the other defects, symbols are specified on the display shape setting field 701 so that the defects can be displayed so as to be visually discriminated from each other. In the example of FIG. 7, a circular mark is specified for a defect without a review image by using a pull-down tab 702, and a square mark is specified for a defect having a review image by using the pull-down tab 703. In FIG. 5, regardless of presence or non-presence of a review image, only the position of the defect 502 is displayed by using a uniform symbol. However, the function of the display shape setting field 701 is used, so that presence and non-presence of a review image are visually discriminated for each defect and the review images are displayed in order to make them obvious to an operator.

A size of a defect is one of a classification item by means of ADC. A symbol of a large defect is enlarged to be displayed on the display size setting field 704 according to a corresponding table 705 showing a relationship between a defect size and a display size as shown in FIG. 6. As a result, defect sizes can be easily understood visually. In the example shown in FIG. 7, three kinds of sizes are present, but a range of a size value is added by an add button 706, or the range of a size value is deleted by a delete button 707, so that contents in the corresponding table 705 can be changed.

Since defects are classified into categories by ADC, when display colors of the defects are determined according to the category numbers, the discrimination of the defects becomes easy. The types of the categories can be specified by a category pull-down tab 710. As shown on a list 709, a relation between the category numbers and the display colors can be determined on the display color setting field 708. The display colors can be added by an add button 711 or can be deleted by a delete button 712.

After the setting on the display setting screen 700 is ended, an OK button 712 is specified by clicking. A cancel button 714 does not change an input value and maintains a value before input.

As shown in FIG. 6, defects 601, 602 and 603 are displayed on the wafer map 501 and the field 503 for displaying a graph in a display form specified on the screen of FIG. 7. When the feature quantities of the vertical axis setting field 504 and the lateral axis setting field 505 in FIG. 6 are changed, a distribution condition of the defects displayed on the field 503 is changed. Some feature quantities are changed, and only the defects, which are classified similarly to the defect 601 and are distributed a lot on a field 604 shown by a triangle, are taken out so that the other defects can be deleted from the display. The triangle can be drawn by a draw button 507, and the displayed triangle is deleted by a clear button 508. A reflect button 509 selects only defects surrounded by the triangle and deletes information about the other defects. Therefore, the defects outside the triangle in the defects displayed on the field 503 of FIG. 6 are deleted, and also corresponding defects on the wafer map 501 are deleted. In this state, when the back button 510 is specified by clicking, defects displayed on the list of defects on the screen of FIG. 4 are only the defects inside the triangle of FIG. 6. In the case where defects on the screen are selected, although defects are mostly distributed so as to be slanted with respect to the axis of the graph, conventionally a square whose sides are parallel with the vertical axis and the lateral axis is used. For this reason, a lot of different kinds of defects are mixed in a region where the distribution of defects is sparse. On the contrary, in this embodiment, since an oblique line is adopted as the sides of a graphic surrounding defects, selection of different kinds of defects can be reduced. This embodiment illustrates the case of the triangle, but a square or a polygon having oblique sides may be adopted.

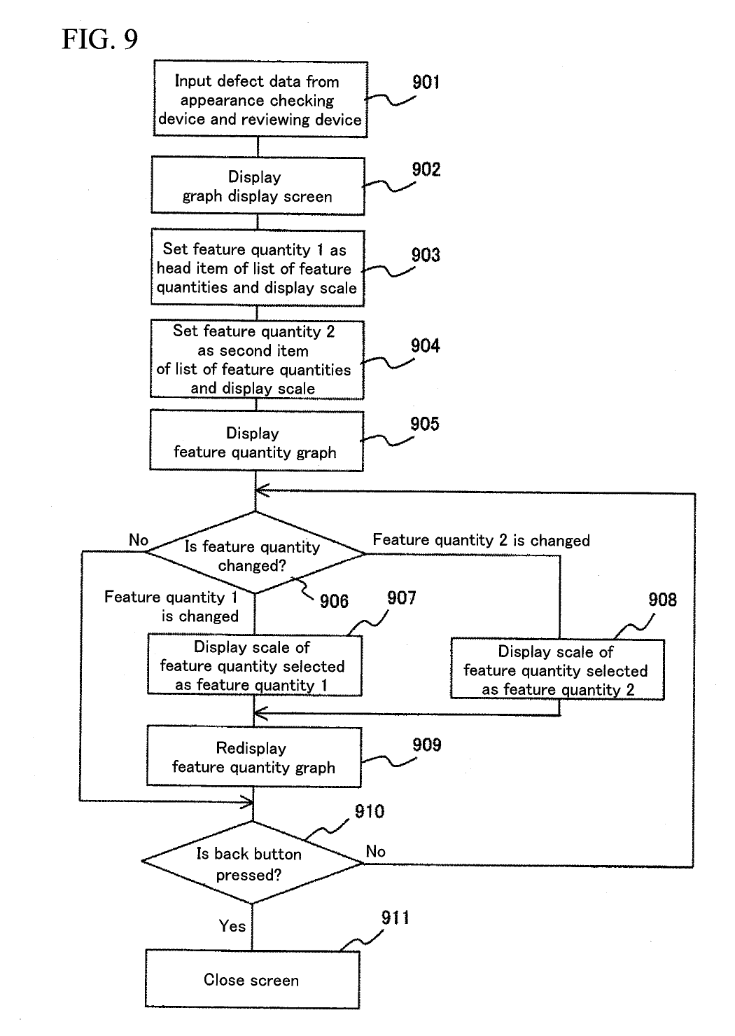

FIG. 9 is a flow chart illustrating a flow of a series of the above procedure. This calculation is carried out by running a software saved in the memory device, not shown, in the computer 26 of the data processor 3 shown in FIG. 2 using a micro processor, not shown. Defect data are input into the data processor 3 shown in FIG. 1 from the appearance checking device 1 and the reviewing device 2 (step 901), and the image list display screen 400 shown in FIG. 4 can be displayed. When the graph display button 408 in FIG. 4 is specified, the graph display screen 500 shown in FIG. 5 is displayed (step 902). When the maximum grey level difference is set for the head item of the list of the feature quantities in the pull-down menu 800 shown in FIG. 8 as a default of the feature quantity 1 of the vertical axis setting field 504 shown in FIG. 5, the maximum grey level difference is set on the vertical axis setting field 504, and a scale of the maximum grey level difference is displayed (step 903). When the reference image average grey level is set for the second item in the list of the feature quantities in the pull-down menu 800 shown in FIG. 8 as the default of the feature quantity 2 of the lateral axis setting field 505, the reference image average grey level is set on the lateral axis setting field 505, and a scale of the reference image average grey level is displayed (step 904). When the defaults are set on the vertical axis setting field 504 and the lateral axis setting field 505 in such a manner, the graph of the feature quantity of the defect shown in FIG. 6 can be automatically displayed (step 905).

When the feature quantities of the vertical axis setting field 504 and the lateral axis setting field 505 in FIG. 6 are changed, a tendency relating to the feature quantities of defects displayed on the field 503 can be changed. A determination is made whether the feature quantity 1 of the vertical axis setting field 504 or the feature quantity 2 of the lateral axis setting field 505 is changed (step 906). When the feature quantity 1 is changed, a scale where the selected feature quantity is plotted along the vertical axis is displayed (step 907). The graph where the feature quantity 1 is changed is redisplayed (step 909). A determination is made whether the back button 510 shown in FIG. 6 is clicked (step 910). When this button is not clicked, the process returns to step 906. Even when both the feature quantity 1 and the feature quantity 2 are changed, a graph of the changed feature quantities can be displayed in this procedure. When the feature quantity 2 is changed, a scale where the selected feature quantity is plotted along the lateral axis is displayed (step 908). A graph where the feature quantity 2 is changed is redisplayed (step 909). When the graph of the feature quantity is redisplayed or the feature quantity is not changed, a determination is made whether the back button 510 shown in FIG. 6 is clicked (step 910). When the back button 510 is clicked, the screen shown in FIG. 6 is closed (step 911).

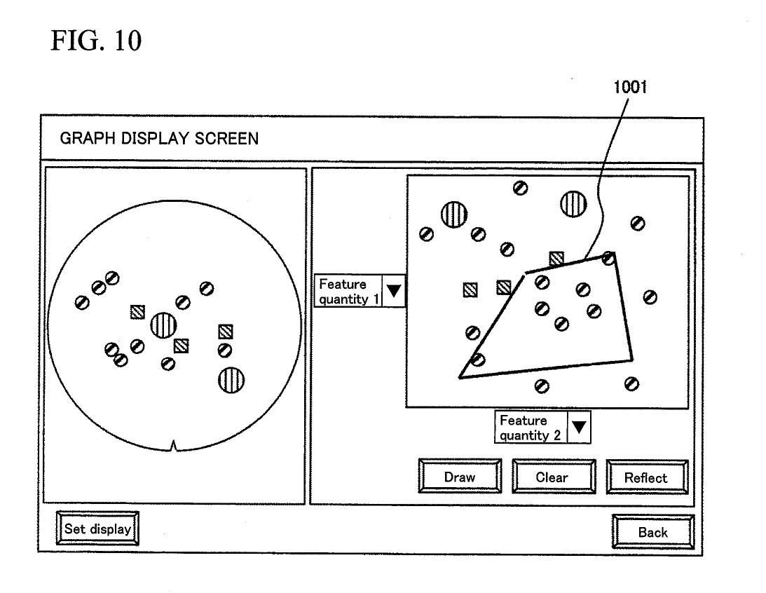

FIG. 10 is a screen diagram illustrating one example of an image to be used for analyzing a feature quantity similarly to FIG. 6. In FIG. 6, defects are surrounded by the field 604 shown by the triangle, and defects which are not surrounded by the field 604 can be eliminated from the display. This field is not limited to the rectangle, and a field 1001 of a square can be specified as shown in FIG. 10. When the draw button 507 in FIG. 6 is specified by clicking, a polygon is started to be drawn. This embodiment illustrates the triangle and the square, but another graphics can be defined and the process can be executed in the similar manner.

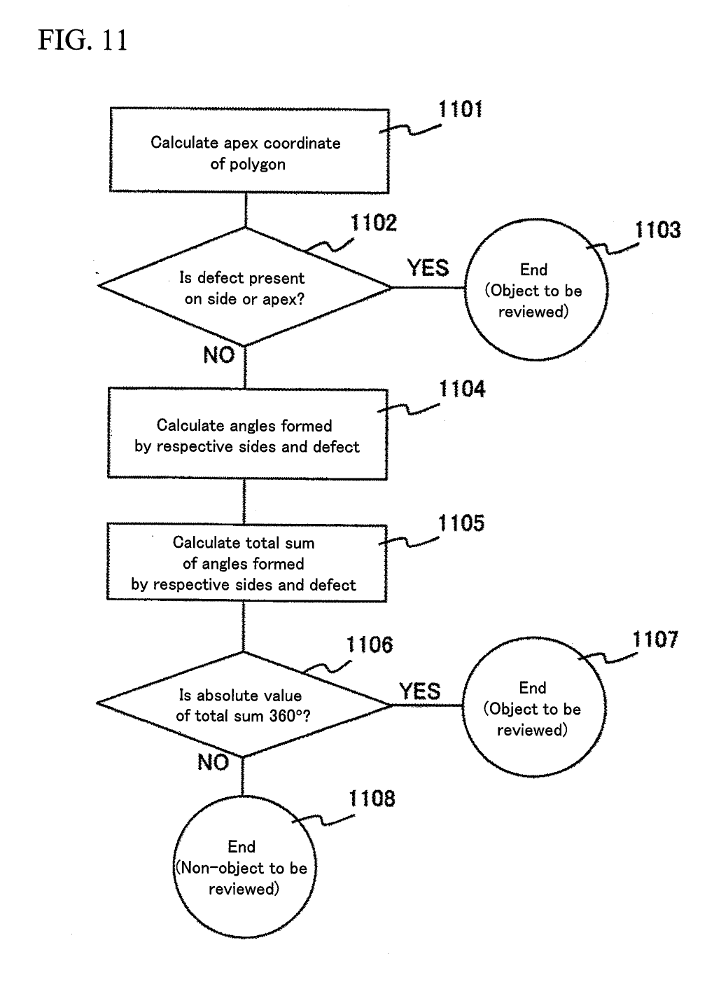

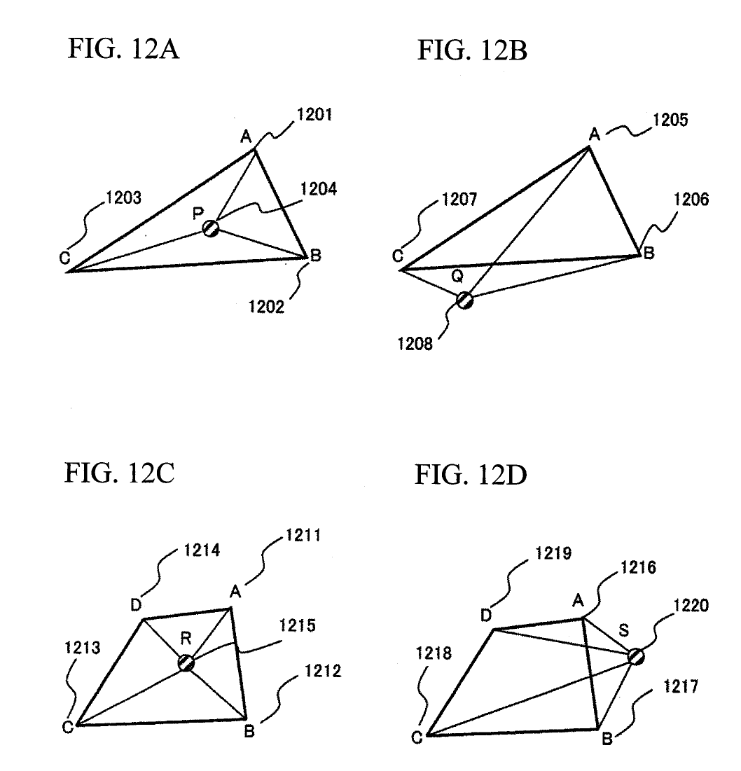

FIG. 11 is a flow chart illustrating a flow of a determination whether defects are subject to be reviewed. FIGS. 12A to 12D are pattern diagrams illustrating definition of respective points at the time of drawing the triangle or the square. When the triangle is drawn, one side of the triangle is firstly drawn. For example, the mouse as the input device of the computer is moved so that the pointer on the screen is moved to a position of an apex of the triangle desired to be drawn, and the button of the mouse is clicked. As a result, the position of the pointer at the time of clicking is stored as the position of the apex of the triangle. For example, as shown in FIG. 12A, when a point A1201 is specified and a point B1202 is specified on the field 503 shown in FIG. 6, one side is determined. When a point C1203 is specified, one side connecting the points C1203 and B1202 is determined. When a vicinity of the point A1201 is specified, one side which connects the points C1203 and A1201 is determined, so that a triangle can be drawn. As shown in FIG. 12C, when a third point C1213 and then a fourth point D1214 which is separated from a first point A1211 are specified and a vicinity of the first point A1211 is specified, a square is determined. In such a manner, the graphic is not limited to the rectangle or the square, and any polygon can be drawn on the field 503. A range of the vicinity for specifying the first point A1201 or A1211 may be set within a specifiable error range where the points can be discriminated using the mouse on the screen. In the description, the points of the graphics are specified in a clockwise direction, but may be specified in a counterclockwise direction.

When the position of the apex of the triangle which was once set is desired to be changed, the pointer is moved to the apex A1201 in FIG. 12A, for example, and while the button of the mouse is being pushed, the mouse is moved, so that the position of the apex A1201 can be changed. At this time, the sides AB and AC are automatically extended according to the movement of the apex A1201, and their positions are changed. In such a manner, the size of the polygon surrounding defects can be arbitrarily changed on the field 503 showing the graph in FIG. 6.

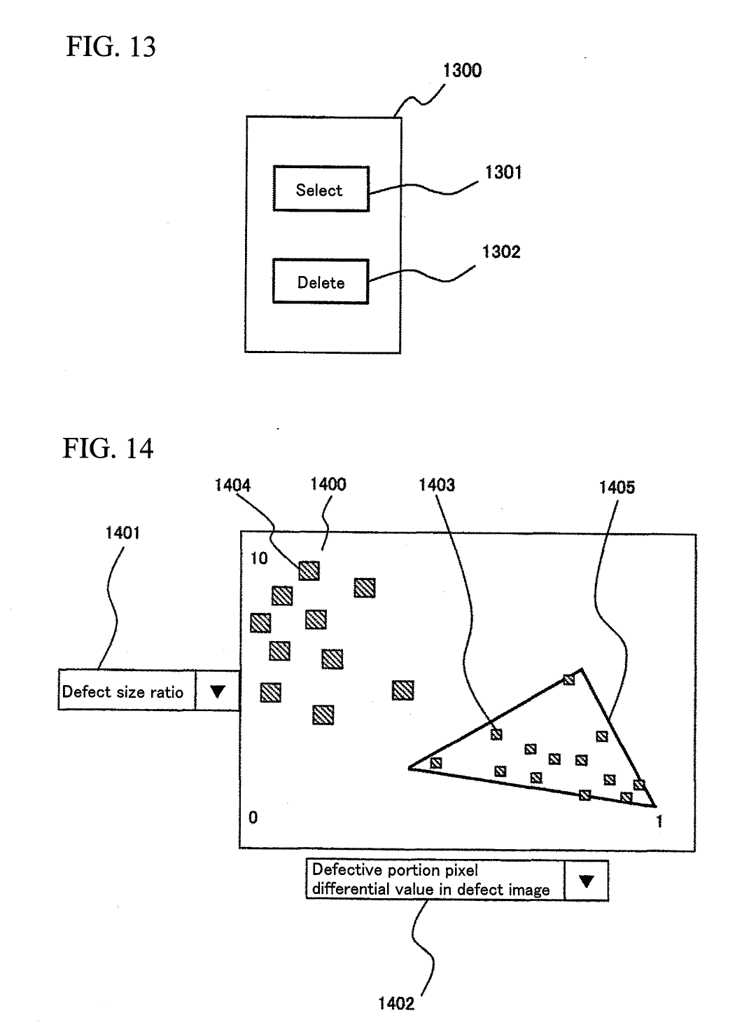

FIG. 13 is a screen diagram illustrating a pull-down menu displayed on the field 503 shown in FIG. 6. When the button of the mouse is clicked inside or outside the polygon, a pull-down menu 1300 is displayed. When the pull-down menu 1300 is displayed inside the polygon and a select button 1301 is specified by clicking, defects inside the polygon are selected. When the reflect button 509 shown in FIG. 6 is specified by clicking, defects outside the polygon are deleted. When a delete button 1302 of the pull-down menu 1300 is specified by clicking inside the polygon, defects inside the polygon are selected. When the reflect button 509 shown in FIG. 6 is specified by clicking, defects inside the polygon are deleted. When the pull-down menu 1300 is displayed outside the polygon and the select button 1301 is specified by clicking, defects outside the polygon are selected. When the reflect button 509 shown in FIG. 6 is specified by clicking, the defects inside the polygon are deleted. When the delete button 1302 of the pull-down menu 1300 is specified by clicking outside the polygon, defects outside the polygon are selected. When the reflect button 509 shown in FIG. 6 is specified by clicking, the defects outside the polygon are deleted. In a convenient manner, a defect which crosses or contacts with the line of the field 604 of the triangle shown in FIG. 6 is defined as being present inside or outside the field 604 in advance. Needless to say, a screen on which a determination is made whether each defect is inside the field 604 may be displayed.

A procedure for determining each defect in the case where a defect inside the polygon displayed on the field 503 shown in FIG. 6 is selected so as to be reviewed is described below with reference to FIG. 1. In FIG. 1, first, a coordinate of the apex of the drawn polygon is calculated (step 1101). The order of the calculation may be a clockwise way or a counterclockwise way. Arbitrary one of the defects displayed on the field 503 is selected, and when a determination is made that the selected defect straddles the apex or a side of the drawn polygon (step 1102), the defect is to be reviewed so that the determination of the defect is ended (step 1103). When the defect does not straddle the apex or the side of the polygon, angles formed by the sides of the polygon and the defect are calculated (step 1104), a total sum of the angles is calculated (step 1105), and a determination is made whether an absolute value of the total sum is equal to 360° (step 1106). When equal, the defect is concluded as a target to be reviewed, and the determination is ended (step 1107). When not equal, the defect is concluded as a non-target object to be reviewed, and the determination is ended (step 1108).

The principle of steps 1104 to 1106 is described. When the angle formed by an apexes of the polygon and the defect exceeds 180°, that angle is subtracted from 360° and a negative symbol is given to it. In FIG. 12A, when a defect P1204 is inside the triangle, the angles formed by an apex A1201, an apex B1202, an apex C1203 and the defect P1204 are APB, BPC and CPA, respectively, and the total sum of the three positive angles is 360°. For this reason, the defect P1204 is determined as being inside the triangle. In FIG. 12B, when a defect Q1208 is outside the triangle, angles formed by an apex A1205, an apex B1206, an apex C1207 and the defect Q1208 are AQB, BQC and CQA, respectively. Since the angle BQC is larger than 180°, when this is subtracted from 360° and a negative symbol is given to it, the sum of the angle AQB and the angle CQA is equal to the absolute value and the symbols are opposite, so that the total sum of the angles become zero. Therefore, the defect Q1208 is determined as being outside the triangle.

The same determination is made on the case of the polygon. In the case of the square shown in FIG. 12C, angles of an apex A1211, an apex B1212, an apex C1213, an apex D1214, and a defect R1215 are ARB, BRC, CRD and DRA. Since the total sum of these angles becomes 360°, the defect R1215 is determined as being inside the square. When a defect S1220 shown in FIG. 12D is outside the square, angles formed by an apex A1216, an apex B1217, an apex C1218, an apex 1219 and the defect S1220 are ASB, BSC, CSD and DSA, respectively. Since the angle ASB is larger than 180°, when it is subtracted from 360° and a negative symbol is given to it, the sum of the angle BSC, the angle CSD and the angle DSA is equal to the absolute value and the symbols are opposite, so that the total sum of the angles becomes zero. Therefore, the defect S1220 is determined as being outside the square.

FIG. 14 is a screen diagram illustrating one example of a graph of the feature quantity displayed on the field 503 shown in FIG. 6. A defect size ratio is set on the vertical axis setting field 1401, and a defective portion pixel differential value in defect image is set on the lateral axis setting field 1402. A lot of defects are displayed on a field 1400, but square defects having about two kinds of sizes are distributed. The specification of the display can be arbitrarily set as described with reference to FIG. 7, and here a size of the graphic on the screen represents a size of a defect, and a square shows that a review image is present. Comparatively small defects 1403 are distributed on a lower right portion of the screen, and comparatively large defects 1404 are distributed on an upper left portion of the screen. The defects which are distributed on the lower right portion have a small size ratio and pixels of the defective portions have a large differential value. That is to say, that the defect size ratio is small means that a fineness ratio is small and that defect has a shape closer to a circle. That the differential value of the pixel is large means a large contrast, and thus the defect is estimated to be a foreign matter which is raised like a mountain, for example. The defects which are distributed on the upper left portion have a large defect size ratio, and the differential value of the pixels on the defective portion is small. That is to say, that the defect size ratio is large means that a fineness ratio is large, and that the differential value of the pixels is small means that a contrast is small. For this reason, for example, the defects are estimated to be scratches with shallow depth. In order to check the defects 1403 distributed on the lower right portion, the defects 1403 are surrounded by the triangle 1405 so as to be selected by a select button 1301 shown in FIG. 13. When the screen is returned to the image list display screen 400 in FIG. 4 by the back button 510 shown in FIG. 6, only the defect IDs corresponding to the selected defects 1403 are displayed, and a check can be made whether the defects are foreign matters on the review image for each defect displayed on the review image field 404.

In this embodiment, the graph where the feature quantities of many defects are plotted on the axes is displayed so that the defects are displayed so as to be capable of being discriminated visually. The feature quantities on the axes of the graph are changed so that the change in the distribution of the defects can be observed. As a result, the characteristic feature quantities on the distribution of the defects are extracted so as to be used for analyzing the causes of defects. Further, defects are surrounded and selected by a polygon having oblique lines on the screen of the graph, and the display of the other defects are deleted, so that only review images of the selected defects can be displayed. For this reason, the review images can be used for analyzing the causes of only the selected defects.

The feature quantities are switched according to defects, the check of review images becomes easy, and false defects, which are detected due to the influence of the defect extracting sensitivity of the appearance checking device, can be easily checked. For this reason, the defect extracting sensitivity of the appearance checking device is changed and defects are compared with each other, so that the checking condition of the appearance checking device for eliminating the false defects can be determined.

What is claimed is:

1. A data processor comprising:
a microprocessor which displays defect checking information and defect review information on one screen of a display, said defect checking information including at least coordinates of a plurality of defects transmitted from an appearance checking device for extracting defects of a sample via a communication line, and said defect review information including at least feature quantities transmitted from a reviewing device for acquiring images of the defects and giving the feature quantities of the defects via said communication line,
wherein a graph field where at least two of said feature quantities are plotted along axes is displayed on said display, and said defects are displayed on positions in the graph field corresponding to said given feature quantities.

2. The data processor according to claim 1, wherein a map which represents distribution of said defects on said sample as well as said graph field is displayed on said screen.

3. The data processor according to claim 1, wherein if said feature quantities of the axes of said graph field are changed, the display of said defects is changed to positions corresponding to the changed feature quantities.

4. The data processor according to claim 1, wherein if said feature quantities of the axes of said graph field are changed, the defects which do not have the changed feature quantities are deleted from said graph field.

5. The data processor according to claim 1, wherein a desired polygon can be drawn on said graph field.

6. The data processor according to claim 5, wherein said polygon comprises at least one oblique side.

7. The data processor according to claim 5, wherein if said defects surrounded by said polygon is selected, the display of unselected defects can be deleted.

8. The data processor according to claim 7, wherein only information about said selected defects is selected from said defect checking information and said defect review information displayed on said screen and is displayed.

9. The data processor according to claim 5, wherein if said defects surrounded by said polygon is selected, the display of said selected defects can be deleted.

10. The data processor according to claim 9, wherein only information about said unselected defects is selected from said defect checking information and said defect review information displayed on said screen and is displayed.

11. A data processing method comprising the steps of:
receiving defect checking information including at least coordinates of a plurality of defects transmitted from an appearance checking device for extracting defects of a sample via a communication line and defect review information including at least feature quantities transmitted from a reviewing device for acquiring images of the defects and giving said feature quantities of said defects via said communication line, displaying a graph field where at least two of said feature quantities are plotted along axes on a display, and
displaying said defects on positions of the graph field corresponding to said given feature quantities.

12. The data processing method according to claim 11, wherein if said feature quantities of the axes of said graph field are changed, the display of said defects is changed to positions corresponding to said changed feature quantities.

13. The data processing method according to claim 11, wherein if said feature quantities of the axes of said graph field are changed, the display of defects which do not have the changed feature quantities is deleted from said graph.

14. The data processing method according to claim 11, wherein a desired polygon can be drawn on said graph field.

15. The data processing method according to claim 14, wherein said polygon comprises at least one oblique side.

16. The data processing method according to claim 14, wherein if said defects surrounded by said polygon is selected, the display of unselected defects can be deleted.

17. The data processing method according to claim 16, wherein only information about said selected defects is selected from said defect checking information and said defect review information displayed on said screen and is displayed.
